(19) United States
(12) Patent Application Publication
(10) Pub. No.: US 2012/0141136 A1
(43) Pub. Date: Jun. 7, 2012

(54) METHOD AND ARRANGEMENT FOR TRANSFERRING DATA FOR THE MAINTENANCE OF A SELF-SERVICE TERMINAL

(75) Inventor: Marco Blume, Paderborn (DE)

(73) Assignee: WINCOR NIXDORF INTERNATIONAL GMBH, Paderborn (DE)

(21) Appl. No.: 13/390,675

(22) PCT Filed: Sep. 9, 2010
(86) PCT No.: PCT/EP10/05537

§ 371 Date: Feb. 15, 2012

(30) Foreign Application Priority Data
Sep. 11, 2009 (DE) 10 2009 040 928.9

(51) Int. Cl. H04L 27/00; H04B 10/00

(52) U.S. Cl. 398/140; 375/259

(57) ABSTRACT

In order to maintain self-service terminals (SS terminals), data must be transferred to a data center by means of telecommunication connections. However, in particularly sensitive fields of application, a direct link of SS terminals to external networks or devices is undesirable. Usually, the maintenance personnel must then access the service and diagnostic data locally at the SS terminal and share said data with the help desk personnel in the data center by telephone. In order to be able to transfer the maintenance and diagnostic data directly between the SS terminal and the data center even without directly linking the SS terminal, the data are transferred in a current-free and radio-free data transfer form in the vicinity of the self-service terminal (100) by means of sending and receiving devices (150, 160, 170; MA, CAM, F). This can occur, e.g., by displaying and reading in barcodes (BCs).

### CROSS-REFERENCE TO RELATED APPLICATIONS

This application is a National Stage of International Application No. PCT/EP2010/005537, filed Sep. 9, 2010, and published in German as WO 2011/029595 A2 on Mar. 17, 2011. This application claims the benefit and priority of German Application 10 2009 040 928.9, filed Sep. 11, 2009. The entire disclosures of the above applications are incorporated herein by reference.

### BACKGROUND

This section provides background information related to the present disclosure which is not necessarily prior art.

### TECHNICAL FIELD

The invention relates to a method for transferring data for the maintenance of a self-service terminal and to an arrangement for carrying out the method. The invention furthermore relates to a self-service terminal configured to carry out the method.

### DISCUSSION

It is known that self-service terminals (also called SS terminals for short), such as automated teller machines, information terminals and the like, are monitored and serviced by means of remote technical maintenance devices. Since the self-service terminals are usually set up or installed at various locations, such as in banks, shopping centers, etc., they are connected by telecommunication links to remote data centers that monitor the status of the self-service terminals. It is additionally known that self-service terminals are serviced and maintained on-site by maintenance personnel. In particularly sensitive application areas, such as exist in the case of automated teller machines, for example, it may be desirable for the particular self-service terminal not to be connected directly over a telecommunication link. In these cases in particular, it is customary for the maintenance personnel themselves to access service and diagnostic data on site at the particular self-service terminal and to store said information on a data carrier, such as a diskette or a memory chip or USB stick, and then to deliver the data carrier in person where the data center is located. It is also quite usual for the maintenance personnel to forward the diagnostic data by telephone over a conventional telephone or a mobile telephone to the central data office.

DE 60 2004 012 052 T2, or corresponding EP 1 542 158 A1, describes a system consisting of a product label with a data memory and an acoustic coupling, or an acoustic signal generator, to transfer product data over a telephone to a product support system. For example, the serial number of a self-service device or a bank teller machine can be stored on the product label that is transferred to the product support system located, for example, in a call center.

U.S. Pat. No. 6,697,466 describes a device in the form of an embedded system in which status data are converted into signals, such as DTMF signals, by means of an audio generator and can be issued over a loudspeaker for transmission over a telephone network or similar.

The point of departure for the present invention is shown in FIG. 1. The schematic drawing represents the typical structure of a system with several self-service terminals to be serviced. The self-service terminals, configured in the example here as automated teller machines 100, are connected to a host 200 over secure data links. These data links, however, serve solely to transfer data that accumulate during while the automated teller machine is in operation and not to transfer information for servicing the automated teller machine. Maintenance is normally performed by appropriate service personnel P, who perform technical diagnosis or inspections on site at the particular self-service terminal and in particular access maintenance or service data. Said data may be, for example, malfunction reports and associated status data that the service technician in question P then forwards to the data center or the help desk located there. To do this, the service technician normally uses a telephone T. The malfunction is then corrected using telephone support from the help desk, when the call agent there has to provide the on-site service technician with telephone instructions or has to request information regarding the diagnostic data, etc. by telephone from said technician. A direct data connection from the self-service terminals 100 to the data center 300 would be desirable. However, this is precisely what is not desirable in particularly sensitive applications. Many self-service terminal operators would like specifically to avoid creating a direct connection between the self-service terminal and a telecommunication link or even an electronic device that the service technician is using. For security reasons, a direct connection to external devices and or networks should be avoided because such a connection would open up opportunities for data attacks and/or planting viruses or similar.

### SUMMARY OF THE INVENTION

Accordingly, it is an object of the present invention to propose a method and an arrangement for transferring data for the maintenance of a self-service terminal in which the aforementioned disadvantages are advantageously overcome. Specifically, a direct connection of the particular self-service terminal to external devices and/or networks is to be avoided, and it should still be possible to transfer maintenance and diagnostic data directly between the self-service terminal and the data center.

Accordingly, it is proposed that data concerning the technical status of the self-service terminal are transferred in a current-free and radio-free transfer form in the vicinity of the self-service terminal by means of sending and receiving devices. Said transfer may specifically involve optical and/or acoustic data transfer forms. The sending and receiving devices are provided with suitable electro-optical or electro-acoustic converters. Accordingly, direct data transfer between the self-service terminal and the data center is possible, where at least on one partial section of the data transfer path, in particular in the vicinity of the self-service terminal, the data are transferred current-free and radio-free. A direct data link is thus enabled, and nevertheless there is the assurance that a direct electrical link, or direct electrical connection, does not result. No radio link subject to interference and/or subject to surveillance is required.

The terms “current-free” and “radio-free” are comprehensible in themselves. In order to understand the unusual combination of the two terms, the following should be noted: Following the generally accepted meaning, “current-free” is understood to mean that the data to be transferred are not transferred through current-conducting lines or electrical conductors, cables and the like. This means that no electrical current (e.g. in the form of electrical data pulses) flows over the actual transfer route. Thus, the term “current-free” is not to be understood as being identical to “cable-free” or “wireless” because, for example, optical data or signal transfers are possible that are carried over “current-free” cables”, namely fiber optic cables. Naturally, the term “current-free” also includes cable-free transmissions in the form of optical and/or acoustic signals. Following the generally accepted meaning, “radio-free” is understood to mean that the transfer does not place over a wireless link, for example over a Bluetooth connection or similar. On the other hand, wireless, inductive data transfers by means of coils and the like are certainly included. Similarly, the aforesaid optical and/or acoustic data transmissions (e.g. light pulses, ultrasound, audio signals in accordance with V.23 or DTMF) are included. The combination of “current-free and radio-free” accordingly excludes only such transfer forms in which electrical signals or radio signals in the narrower sense are transmitted.

The invention also proposes an arrangement for carrying out the method as well as a self-service terminal that is provided with sending and receiving devices to carry out current-free and radio-free data transfer of this kind.

### BRIEF DESCRIPTION OF THE DRAWINGS

The invention is described in greater detail hereinafter using embodiments and with reference to the additional appended drawings.

The drawings described herein are for illustrative purposes only of selected embodiments and not all possible implementations, and are not intended to limit the scope of the present disclosure.

FIG. 2 shows an inventive arrangement in accordance with a first embodiment in a schematic representation.

FIG. 3 shows an arrangement in accordance with a second embodiment in a schematic representation.

FIGS. 4a and 4b show the sending and receiving devices used in the arrangement in greater detail.

FIG. 5 shows a schematic flow chart for a method in accordance with the invention.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

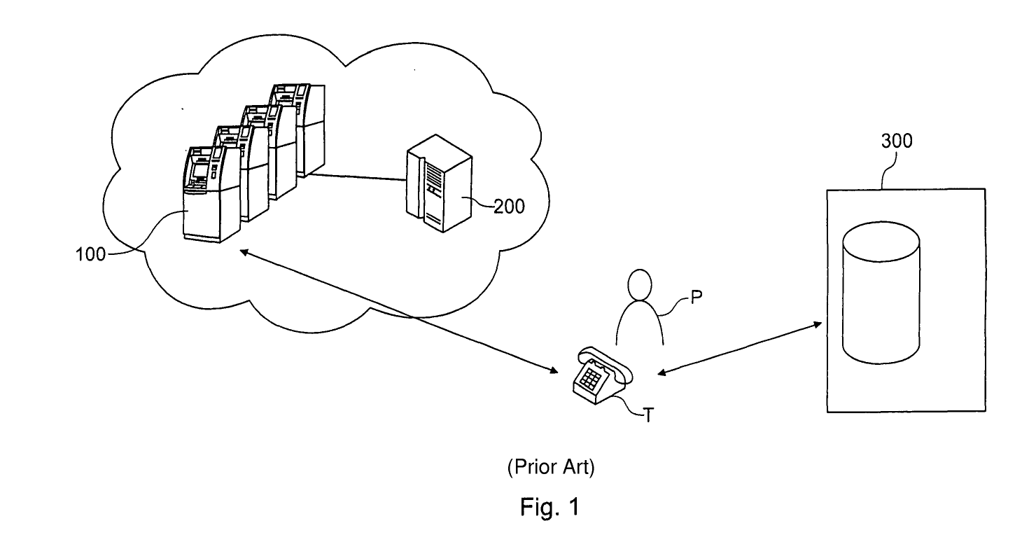

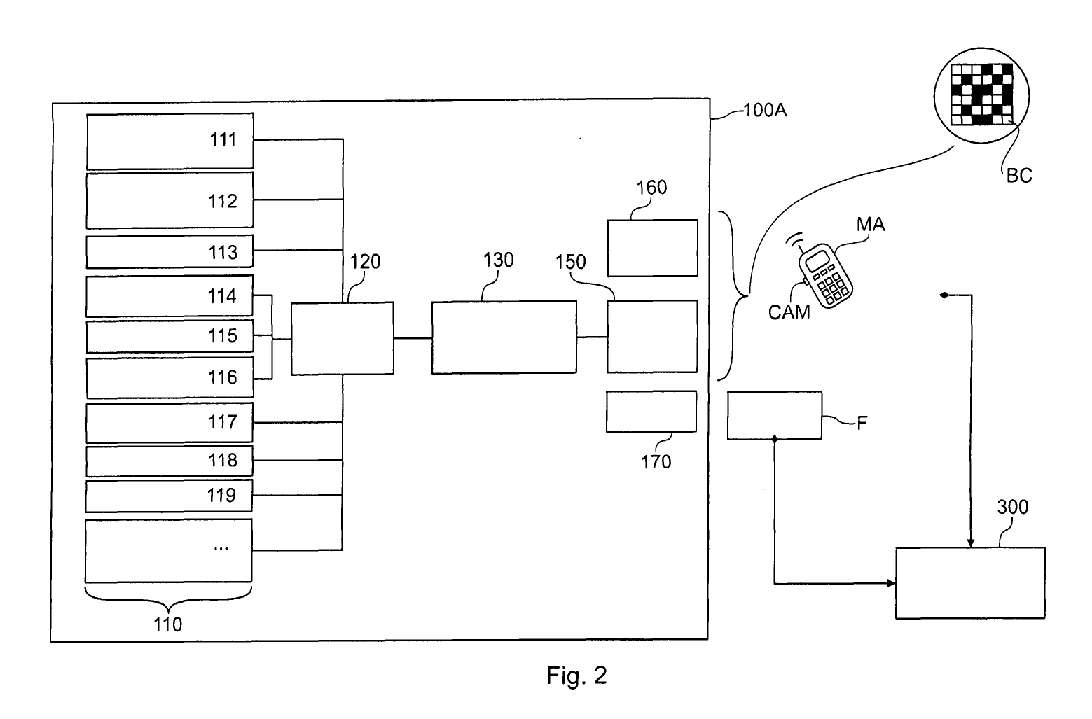

As a first embodiment, an arrangement is shown in FIG. 2 that comprises a self-service terminal 100A in the form of an automated teller machine. Several sending devices are provided, here in the form of monitors 150 or 160, as well as printers. The sending devices are configured to convert the data to be sent, specifically status data or service data that initially exist as electronic data signals, into a data form that involves neither current nor radio waves. Several receiving devices are provided for the current-free and radio-free reception of the data, for example a camera CAM or a fax machine F. The receiving devices are configured to convert the data received into electronic signals again in order to forward said data over a data or telecommunication link to a data center 300.

In the example shown here, the data are transferred in the form of an optical data transfer by the automated teller machine 100A to at least one device that is operated by the service technician. The device has a suitable receiving device, here for example a camera CAM. The data are then transferred in electronic form, preferably over a telecommunication link, by the device, which can be a telecommunication device, specifically a mobile telephone MA, to the data center 300.

As FIG. 2 illustrates, the data transfer can be made in the form of barcodes BC, for example, where the self-service terminal 100A is furnished with suitable optical sending devices or display devices that are configured here as monitors 150 or 160, or as printers. If, for example, the data to be transferred are displayed on the customer monitor 150 as a matrix code BC (a 2-D matrix) or as a barcode, this matrix code or barcode can be read in by means of a camera. In what follows, these codes are collectively referred to by the term barcode.

In the example shown, the camera CAM of the mobile telephone MA that the service technician carries with him anyway is used for this purpose. As soon as the camera CAM has read in barcode(s), the corresponding data can be transferred further over the mobile telephone MA to the data center 300 over conventional telecommunication or mobile telephone links. In this way, a direct data exchange between the self-service terminal 100A and the data center 300 is established.

The data transfer can also take place in the opposite direction; for instance, the mobile telephone MA displays the data coming from the data center 300 as a barcode or visually in another manner on the screen of the mobile telephone MA, where a camera is provided at the self-service terminal that in turn reads in this barcode and thus receives the data derived from said barcode. A monitoring camera that is being used anyway could serve this purpose.

As an alternative to displaying the barcode BC on the customer monitor 150 or on the operator monitor 160, provision can be made for the barcode(s) BC to be sent over the printer 170 of the self-service terminal 100A. In this case, the service technician removes the paper output by the printer with the barcodes printed thereon and places the printed paper in the fax machine F. The barcodes are read in there and forwarded as electronic data over the telecommunication network to the data center 300. Bidirectional data transfer is thus possible in this manner.

In most applications, however, unidirectional data transfer is adequate, with which service data originating from the self-service terminal 100 are transferred to the data center 300. The data transfer itself can take place without the assistance of the service technician. He has only to ensure that a telecommunication link to the data center is established.

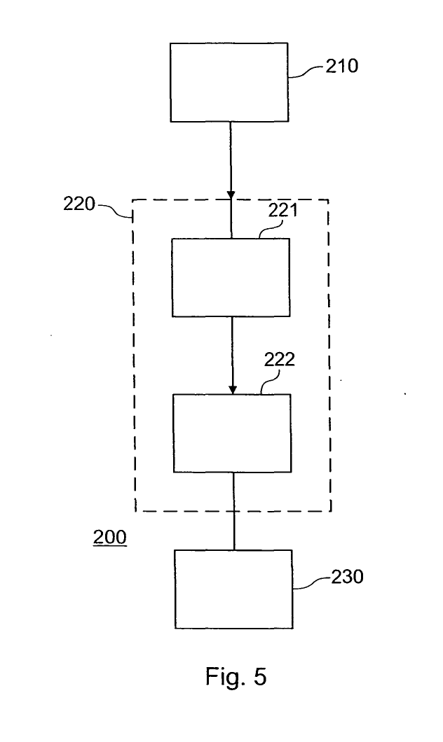

In what follows, the proposed method for transferring data will be described as an example, with reference being made to FIG. 5 that contains a schematic representation for this purpose in the form of a flow chart.

The method 200 starts with a step 210 in which service data are requested from the self-service terminal or automated teller machine 100A. This is achieved, for example, by the service technician pressing a specific operating button on the automated teller machine or by entering a specific code over the keypad. Preparation of the requested data and their visual display is thereupon activated in the automated teller machine 100A, as well as current-free and radio-free near field transfer (see sequence of steps 220). To do this, a maintenance diagnostic data generator 120 (see also FIG. 2) accesses the status of different modules or units 110 within the automated teller machine 100A. Then the maintenance diagnostic data generator 120 generates the desired data regarding the status of the various components or modules 110. The generator 120 provides all the data or information to be transferred in a consolidated form. The information is then displayed as a barcode BC at a request from the operator or on-site technician (e.g. entering a command, pressing a key or key combination). To do this, the data are converted into a barcode display form inside a downstream transformation unit 130. Steps 120 and 130 can be implemented as software in such a way that the diagnostic and service platform sits on one driver level (step 120); in turn a TSOP (Technical Service and Operations Program) sits on this level (step 130) that also forms the human-machine interface to the diagnostic and service platform. The barcode display form in turn is displayed on the customer monitor 150. The step in the method for the visual display of the data in the form of a barcode is shown in FIG. 5 as step 221.

In a subsequent step 222, the device MA which was brought by the service technician and is equipped with camera CAM can now optically read in the barcodes BC and thus the data. The mobile telephone device MA of the service technician is preferably employed for this purpose.

Then, in a further step 230, data transfer to the data center 300 can take place over a telecommunication network in the conventional sense. For this purpose, the data read in by the camera CAM are converted in the mobile telephone MA, and a radio data transfer is carried out, for example following the GSM standard.

As was described using FIG. 2 and FIG. 5, the self-service terminal is not connected either electrically or by radio to external devices or networks, but rather a secure and surveillance-free data transfer takes place in the vicinity, configured here, for example, as an optical data transfer.

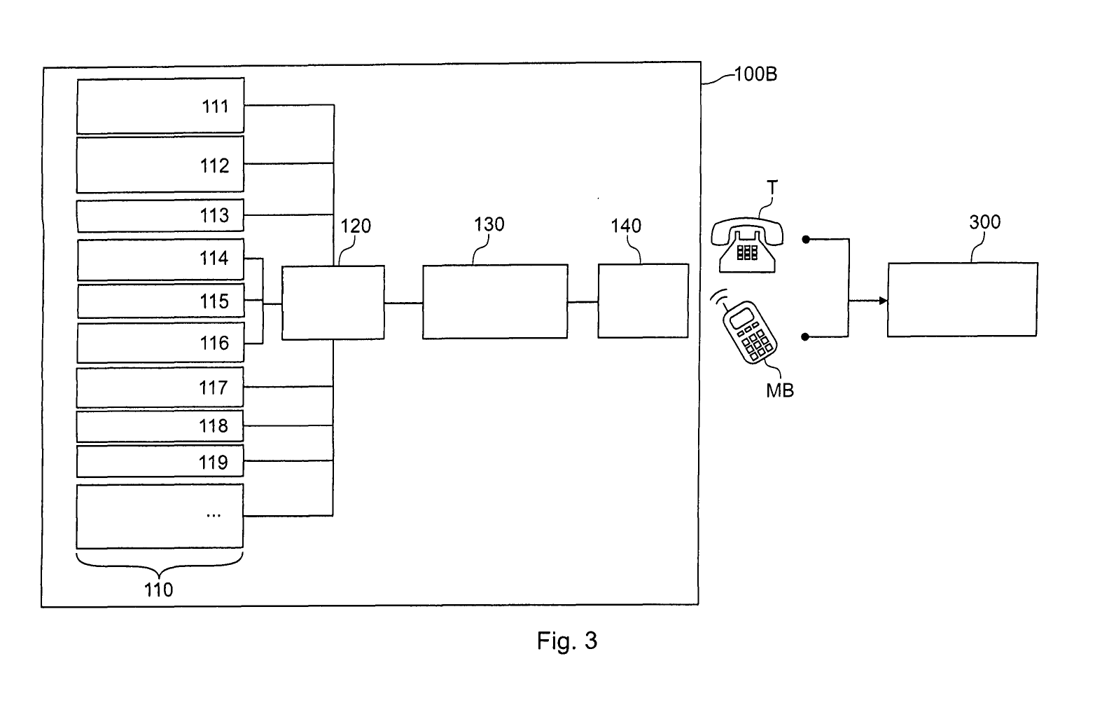

FIG. 3 shows a further embodiment in which the data transfer takes place in the form of acoustic signals. A self-service terminal or an automated teller machine 100B is provided for this purpose, furnished with an acoustic coupler 140 that in turn is suitable for sending acoustic signals and coupling said signals into a conventional telephone T or a mobile telephone MB. From there, the data are converted into electrical signals and transferred over conventional telecommunication networks to the data center 300.

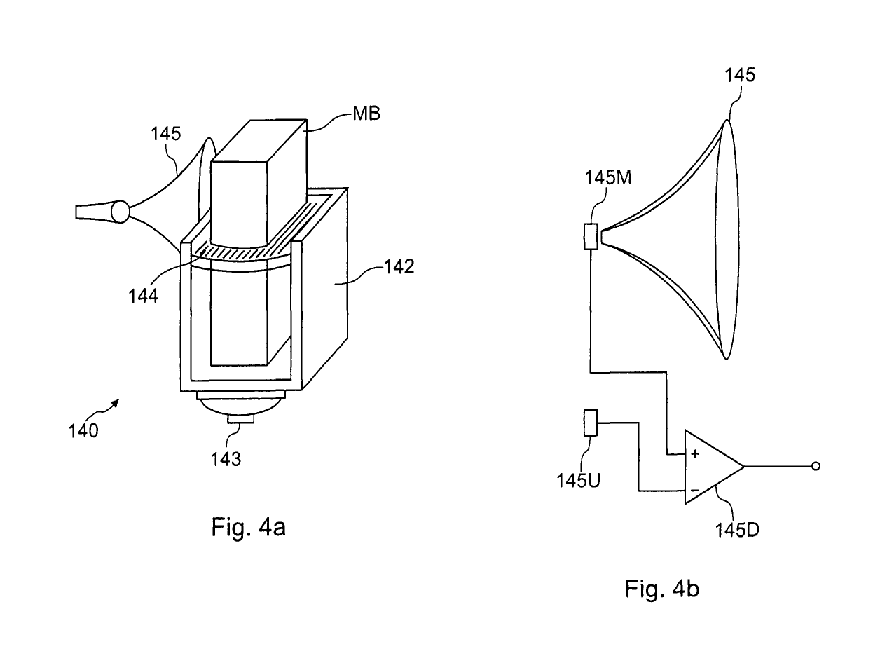

FIGS. 4a and 4b show in detail the construction of such an acoustic coupler of this type 140. As FIG. 4a shows, the acoustic coupler 140 is designed to accept a mobile telephone MB. The acoustic coupler has a bracket 142 for this purpose that is configured for acoustic shielding and thus for interference-free transfer of sounds. The acoustic coupler specifically has a loudspeaker 143 that sends appropriate sound signals that are received in turn by the microphone on the mobile telephone MB. As an alternative, the sounds can be modulated in accordance using the V.23 modulation method or, at lower data transfer rates, using the DTMF principle.

One loudspeaker 143 would suffice for unidirectional transfer from the automated teller machine 100B to the data center 300 (see also FIG. 3). For a bidirectional link an additional microphone funnel 145 with a matching microphone 145M is provided. As FIG. 4B shows in greater detail, microphone 145M is furnished with a funnel 145 that is placed against the loudspeaker of mobile telephone MB and can thus receive acoustic signals sent by the mobile telephone. These signals could be fed directly into a data processor of the automated teller machine 100B as electrical signals. However, to prevent ambient noise from interfering with the acoustic signals received, an additional ambient microphone 145U is provided. Using a differential amplifier 145D, both microphone signals are combined, when the signal from the ambient microphone 145U is separated from the signal of the actual microphone 145M. A clean signal is provided that allows better and interference-free data evaluation.

The acoustic coupler 140 shown here can, as an example, be integrated directly into the self-service terminal 100B. It can also be mounted as an additional device to or in the vicinity of the self-service terminal 100B. As is shown specifically from FIG. 4a, the acoustic coupler has a conical shape and can thus be adapted to the maximum number of mobile telephone designs possible. The funnel shape 145 is designed such that it covers as many mobile telephone designs and loudspeaker positions as possible. A rubber lip 144 provides a secure seal against the mobile telephone housing. Because the acoustic coupler, or the funnel, covers only the lower half of the telephone, decoupling between the microphone part and the loudspeaker part is ensured. Electromagnetic shielding measures can be provided in addition that prevent the radio emissions emanating from the mobile telephone from compromising the microphones 145M and 145U or the downstream electronics.

The current-free and radio-free data transfer proposed here is able to provide sufficiently high transfer rates. It has been shown that it is often adequate for maintenance purposes to provide data transfer of several kbit/s. Transmission by an acoustic coupler has the particular advantage that simple and older telecommunication devices and the simplest telephones can be connected.

The optical data transfer described here likewise has the specific advantage that the data transfer can be carried out over already existing display devices, such as monitors or printers as well as over fax machines. In addition to the optical or acoustic data transfers explicitly described, the implementation of other forms of current-free and radio-free data transfer is also conceivable. For example, inductive data transfer by means of electro-magnetic coils could also be realized.

The invention is particularly suited for use in self-service terminals that are not provided directly with external devices or external network connections, as is the case with automated teller machines. The field of application of the invention is, however, not restricted to said teller machines alone, but can be employed for any form of self-service terminal.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method for transferring data for the maintenance of a self-service terminal in which data that pertain to the technical status of the self-service terminal are transferred between the self-service terminal and a remote data center over a telecommunication link, comprising wherein the data are transferred in the vicinity of the self-service terminal over sending and receiving devices in a current-free and radio-free data transfer form.

2. The method according to claim 1, wherein the data are transferred in an optical data transfer form, specifically are transferred in a data transfer form based on barcodes.

3. The method according to claim 1, wherein the data are transferred in an acoustic data transfer form, specifically in a data transfer form based on the V.23 modulation method or the DTMF principle (dual-tone multi-frequency).

4. The method according to claim 1, wherein:
in a first step the data are accessed at the self-service terminal; in a next step the data are converted from electrical data signals and are sent by a sending device in an optical and/or acoustic display format; in a next step the data are received by a receiving device in the optical or acoustic display format and converted into electrical data signals; and in a next step are transferred as electrical data signals over the telecommunication link to the remote data center.

5. An arrangement for transferring data for the maintenance of a self-service terminal, wherein the arrangement is configured to transfer data that pertain to the technical status of the self-service terminal between the self-service terminal and a remote data center over a telecommunication network, characterized in that the arrangement comprises sending and receiving devices to transfer the data in a current-free and radio-free data transfer form in the vicinity of the self-service terminal.

6. The arrangement according to claim 5, wherein the sending and receiving devices comprise electro-optical and/or electro-acoustic converters.

7. The arrangement according to claim 5, wherein the arrangement comprises at least one sending device in the form of at least one monitor, a printer and/or an acoustic coupler.

8. The arrangement according to claim 5, wherein the arrangement comprises at least one receiving device in the form of at least one telecommunication device, specifically a telephone, a mobile telephone and/or a fax machine.

9. The arrangement according to claim 8, wherein the mobile telephone has a camera.

10. A self-service terminal for an arrangement for the transfer of data for the maintenance of the self-service terminal, comprising wherein the arrangement is so designed to transfer data that pertain to the technical status of the self-service terminal between the self-service terminal and a remote data center over a telecommunication network, wherein the self-service terminal comprises at least one sending device to transfer the data in the vicinity of the self-service terminal in a current-free and radio-free data transfer form to at least one receiving device of the arrangement.

11. The self-service terminal according to claim 10, wherein the at least one sending device comprises electro-optical and/or electro-acoustic converters.

12. The self-service terminal according to claim 10, wherein the at least one sending device is configured as at least one monitor, one printer and/or an acoustic coupler.

13. The self-service terminal according to claim 10, wherein the self-service terminal comprises at least one receiving device, specifically a camera and/or an acoustic coupler.

14. The self-service terminal according to claim 10, wherein the self-service terminal comprises a data generator unit that is connected to at least one module of the self-service terminal and generates the data concerning the status of the at least one module.

15. The self-service terminal according to claim 14, wherein the self-service terminal comprises a data transformation unit connected to the data generator unit that converts the data to be sent about the at least one sending device into a specifiable data transfer form.
